(19) United States
(12) Patent Application Publication
(10) Pub. No.: US 2018/0058842 A1
(43) Pub. Date: Mar. 1, 2018

(54) APPARATUS FOR MEASURING INTERNAL STRAIN FIELD OF DENTAL RESIN

(71) Applicant: Guangdong University of Technology, Guangzhou City (CN)

(72) Inventors: Shengli Xie, Guangzhou City (CN); Chuangliang Xie, Guangzhou City (CN); Zhaoshui He, Guangzhou City (CN); Yanzhou Zhou, Guangzhou City (CN); Kan Xie, Guangzhou City (CN); Haochuan Zhang, Guangzhou City (CN)

(21) Appl. No.: 15/638,494

(22) Filed: Jun. 30, 2017

(30) Foreign Application Priority Data
Aug. 24, 2016 (CN) 201610718227.9

(51) Int. Cl. G01B 11/16; A61C 19/04

(52) U.S. Cl. CPC G01B 11/16; G01B 11/22; A61C 19/04

(57) ABSTRACT

The present disclosure discloses an apparatus for measuring an internal strain field of a dental resin, comprising: an optical measurement system, a probe and a data processor, wherein an optical fiber coupler in the optical measurement system has one input terminal connected to a light source, one output terminal connected to the probe, the other output terminal provided with an optical component including a reflective element for forming reference light and the other input terminal provided with an photoelectric imaging apparatus for receiving interference light formed by object light and the reference light. The probe is configured to irradiate detection light outputted from the optical fiber to a measured tooth and receive object light which is reflected by the tooth; and the data processor is configured to obtain a measurement result of the internal strain field of the measured dental resin according to an interference spectrum obtained through imaging by the photoelectric imaging apparatus. The apparatus for measuring an internal strain field of a dental resin according to the present disclosure achieves online measurement of a distribution of the internal strain field of the resin based on the interference tomography measurement method, so as to detect an internal defect of the resin according to a change of the internal strain field of the resin under a stress.

### CLAIM FOR PRIORITY

This application claims the benefit of priority of Chinese Application Serial No. 201610718227.9, filed 24 Aug. 2016, which is incorporated herein by reference in its entirety.

### TECHNICAL FIELD

The present disclosure relates to the field of dental detection technology, and more particularly, to an apparatus for measuring an internal strain field of a dental resin.

### BACKGROUND

Dental resin is a tooth color restoration material which is a widely used in clinical practice, and has advantages such as a good appearance for repair of teeth, less cutting of teeth during the repair etc. In the repair process, the material will change from a full plastic state when the material is filled in a cavity to a final high rigid and elastic state after the material is cured through polymerization reaction. In this process, volume contraction occurs, which generates a contraction stress. The contraction stress may affect the resin itself and a bonding interface thereof, which may leads to defects such as holes, cracks, gaps etc. in the dental resin. In this case, it will clinically cause defects such as micro-leakage, edge staining, secondary caries, postoperative sensitivity, enamel cracking etc. after resin repair. In the prior art, detection of the defects in the dental resin is carried out using the conventional three-dimensional finite element analysis theory, but it is difficult to obtain a detection result consistent with the practical situations.

In recent years, it is found through research in the field of material detection that when the material having defects such as holes, gaps, cracks etc. therein deforms under a force, a portion of the material surrounding the defects may form a stress concentration area, and a stress applied to material in this region is much greater than stresses in other positions, and correspondingly this region may significantly deform. Therefore, the internal defects of the material can be analyzed and detected according to the internal strain condition when the material is under a stress.

### SUMMARY

In view of this, the present disclosure provides an apparatus for measuring an internal strain field of a dental resin, which obtains an interference spectrum of a plurality of layers within the measured dental resin based on the optical interference principle, and obtains a strain distribution in the resin according to the interference spectrum, so as to detect internal defects of the resin according to a change of the internal strain field of the resin under a stress.

In order to achieve the above purposes, the present disclosure provides the following technical solutions:

An apparatus for measuring an internal strain field of a dental resin, comprising; an optical measurement system, a probe and a data processor, wherein
the optical measurement system comprises a light source for providing coherent light, an optical fiber coupler, an optical component and a photoelectric imaging apparatus, wherein the optical fiber coupler has one input terminal connected to the light source, one output terminal connected to the probe through an optical fiber, the other output terminal provided with the optical component including a reflective element for forming reference light and the other input terminal provided with the photoelectric imaging apparatus for receiving interference light formed by object light and the reference light,
the probe is configured to irradiate detection light outputted from the optical fiber to a measured tooth and receive object light which is reflected by the tooth; and
the data processor is connected to the photoelectric imaging apparatus, and is configured to obtain a measurement result of the internal strain field of the measured dental resin according to an interference spectrum obtained through imaging by the photoelectric imaging apparatus.

Alternatively, the optical component comprises at least a first lens, a first reflector, an optical path adjustment component and a second reflector disposed in turn along an optical path;
the first lens is configured to adjust output light from the optical fiber to parallel light;
a normal of the first reflector is at an angle of 45 degrees to a central axis of the first lens;
the optical path adjustment component comprises at least a third reflector and a fourth reflector disposed perpendicularly to each other and having respective reflection surfaces opposite to each other, the third reflector being parallel to the first reflector, and the second reflector being opposite to the fourth reflector with an angle of 45 degrees between a normal of the second reflector and a normal of the fourth reflector;
reflection light from the first reflector is incident on the third reflector at an incident angle of 45 degrees, and after the light is reflected by the third reflector and the fourth reflector in turn, reflection light from the fourth reflector is incident on the second reflector perpendicularly; and
the optical path adjustment component is displaceable in a direction of incident light thereon.

Alternatively, the optical measurement system is connected to the probe via a fiber jumper.

Alternatively, a second lens, a reflective diffraction grating, and a third lens are disposed in turn on an optical path between the input terminal of the optical fiber coupler and the photoelectric imaging apparatus.

Alternatively, at least a fourth lens for adjusting a light beam is disposed in the probe.

Alternatively, the optical fiber coupler is an optical fiber coupler having a splitting ratio of 50:50.

Alternatively, the photoelectric imaging apparatus is a Charge Coupled Device (CCD) camera.

Alternatively, the data processor is configured to obtain a measurement result of the internal strain field of the measured dental resin according to an interference spectrum by:
calculating the collected interference spectrum using the following equation:

$$I ( k ) = DC + AC + 2 {\sum }_{j = 1}^{M} \sqrt{{I}_{R} {I}_{j}} cos ( {φ}_{j 0} + 2 k \cdot {Λ}_{j} ) ;$$

where I(k) represents the intensity of the interference light, DC represents a direct current component, AC represents a self-coherent component, I_{R} represents intensity of the reference light, Iⱼ represents intensity of reflection light from a j^{th} surface, k is a wave number, k=2π/λ, λ is a wavelength, M is a number of surfaces involved in the interference, φⱼ₀ is an initial phase when interference occurs between a reference plane and the j^{th} surface, and λⱼ is an optical path difference between the j^{th} surface and the reference plane; and
calculating a distance zⱼ between the j^{th} surface and the reference plane in the dental resin in accordance with the following equation:

$${z}_{j} = \frac{{Λ}_{j + 1} - {Λ}_{j}}{{n}_{j}} + {\sum }_{i = 1}^{j - 1} \frac{{Λ}_{i} - {Λ}_{i - 1}}{{n}_{i - 1}} ;$$

where nⱼ represents a refractive index, and Λⱼ is calculated using the following equation:

$${f}_{k} = \frac{1}{2 π} \cdot \frac{\partial ( {φ}_{j 0} + 2 k \cdot {Λ}_{j} )}{\partial k} = \frac{{Λ}_{j}}{π} ;$$

where fₖ represents a change frequency of the interference spectrum along a wave number k axis.

Alternatively, the data processor is configured to obtain a measurement result of the internal strain field of the measured dental resin according to an interference spectrum by:
calculating an off-plane displacement wⱼ of the j^{th} surface in the dental resin according to the following equation:

$${w}_{j} = \frac{{Δφ}_{j}}{2 {k}_{c} \cdot {n}_{j - 1}} + \frac{1}{{n}_{j - 1}} {\sum }_{i = 1}^{j - 1} \{ [ {w}_{i - 1} - {w}_{i} ] \cdot {n}_{i - 1} + ( {z}_{i - 1} - {z}_{i} ) \cdot Δ {n}_{i - 1} \} + ( {z}_{j - 1} - {z}_{j} ) \cdot \frac{Δ {n}_{j - 1}}{{n}_{j - 1}} + {w}_{j - 1} ;$$

where Δφⱼ represents a phase difference between interference spectrums before and after deformation, k_{c} represents a central wave number of output light from the light source, and Δnⱼ represents a difference between refractive indexes before and after the deformation; and
calculating the off-plane strain εⱼ of the j^{th} surface in the dental resin according to the following equation:

$${ɛ}_{j} = \frac{\partial {w}_{j}}{\partial z} = \frac{1}{2 {k}_{c} \cdot {n}_{j}} \cdot \frac{\partial {Δφ}_{j}}{\partial z} - \frac{Δ {n}_{j}}{{n}_{j}} .$$

It can be seen from the above technical solutions that the apparatus for measuring an internal strain field of a dental resin according to the present disclosure comprises a probe, an optical measurement system and a data processor, wherein the optical measurement system comprises a light source, an optical fiber coupler, an optical component and a photoelectric imaging apparatus. In the optical measurement system, coherent light generated by the light source enters the optical fiber coupler, and a part of the light is output to the probe through one output terminal of the optical fiber coupler for irradiating a measured tooth; and the other part of the light is output to the optical component to form reference light for return. Interference occurs between the object light reflected by the measured tooth and the reference light in the optical fiber coupler, to form interference light which is received by the photoelectric imaging apparatus to obtain an interference spectrum. The dental resin has a multi-layer structure. Detection light is irradiated to the resin, reflection light is formed from each layer, and interference occurs between the reflection light and the reference light to obtain the interference spectrum. A distribution of the internal strain field of the measured dental resin can be obtained according to the measured interference spectrum.

The apparatus for measuring an internal strain field of a dental resin according to the present disclosure measures to obtain an interference spectrum of multiple layers in the dental resin based on the optical interference theory, and obtains the distribution of the internal strain field of the dental resin based on the interference spectrum, which achieves online measurement of the internal strain field of the dental resin and can further analyze and detect the internal defects of the dental resin according to the change of the internal strain distribution of the dental resin when the resin is under a stress.

### BRIEF DESCRIPTION OF THE DRAWINGS

In order to more clearly illustrate the embodiments of the technical solutions in the embodiments of the present disclosure or in the prior art, the accompanying drawings, which are to be used in the description of the embodiments or the prior art, will be briefly described below. It will be apparent that the accompanying drawings in the following description are merely some embodiments of the present disclosure, and other accompanying drawings can be obtained by those skilled in the art according to these accompanying drawings without contributing any creative labor.

FIG. 1 is a diagram of an apparatus for measuring an internal strain field of a dental resin according to an embodiment of the present disclosure;

FIG. 2 is a diagram of an apparatus for measuring an internal strain field of a dental resin according to another embodiment of the present disclosure; and

FIG. 3 is a diagram of a multi-layer structure model in a dental resin established according to an embodiment of the present disclosure.

### DETAILED DESCRIPTION

In order to enable those skilled in the art to better understand the technical solutions in the present disclosure, the technical solutions in the embodiments of the present disclosure will be clearly and completely described below in conjunction with the accompanying drawings in the embodiments of the present disclosure, and it is obvious that the described embodiments are merely a part of the embodiments of the present disclosure instead of all the embodiments. All other embodiments obtained by those of ordinary skill in the art based on the embodiments of the present disclosure without making any creative labor are within the protection scope of the present disclosure.

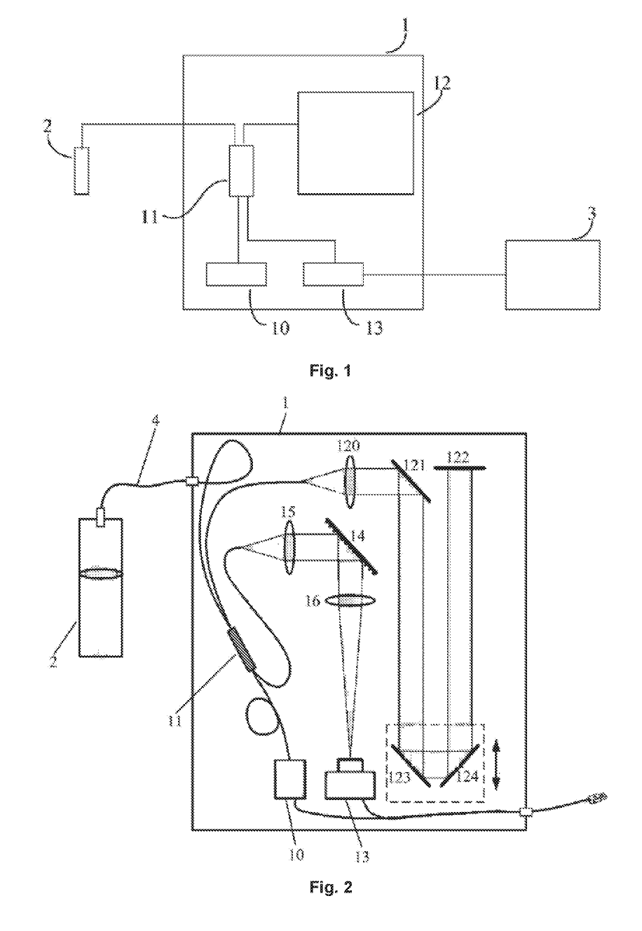

As shown in FIG. 1, illustrated is a diagram of an apparatus for measuring an internal strain field of a dental resin according to an embodiment of the present disclosure. The apparatus for measuring an internal strain field of a dental resin according to the present embodiment comprises an optical measurement system 1, a probe 2 and a data processor 3.

The optical measurement system 1 comprises a light source 10 for providing coherent light, an optical fiber coupler 11, an optical component 12 and a photoelectric imaging apparatus 13, wherein the optical fiber coupler 11 has one input terminal connected to the light source 10, one output terminal connected to the probe 2 through an optical fiber, the other output terminal provided with the optical component 12 including a reflective element for forming reference light and the other input terminal provided with the photoelectric imaging apparatus 13 for receiving interference light formed by object light and the reference light.

The probe 2 is configured to irradiate detection light outputted from the optical fiber to a measured tooth and receive object light which is reflected by the tooth.

The data processor 3 is connected to the photoelectric imaging apparatus 13, and is configured to obtain a measurement result of the internal strain field of the measured dental resin according to an interference spectrum obtained through imaging by the photoelectric imaging apparatus.

The apparatus for measuring an internal strain field of a dental resin according to the present embodiment comprises a probe 2, an optical measurement system 1 and a data processor 3, wherein the optical measurement system 1 comprises a light source 10, an optical fiber coupler 11, an optical component 12 and a photoelectric imaging apparatus 13. In the optical measurement system, coherent light generated by the light source 10 enters the optical fiber coupler 11, and a part of the light is output to the probe 2 through one output terminal of the optical fiber coupler for irradiating a measured tooth; and the other part of the light is output to the optical component 12 to form reference light for return, Interference occurs between the object light reflected by the measured tooth and the reference light in the optical fiber coupler 11, to form interference light which is received by the photoelectric imaging apparatus 13 to obtain an interference spectrum.

The measured dental resin has a multi-layer structure. Detection light is irradiated to the tooth, reflection light is formed from each layer, and interference occurs between the returned reflection light from each layer and the reference light to obtain the interference spectrum. An internal strain distribution of the measured dental resin may be calculated according to the obtained interference spectrum. Therefore, the apparatus for measuring an internal strain field of a dental resin according to the present embodiment obtains an interference spectrum of multiple layers in the dental resin based on the optical interference theory, and obtains the distribution of the internal strain field of the dental resin based on the interference spectrum.

The apparatus for measuring an internal strain field of a dental resin according to the present embodiment obtains the distribution of the internal strain field of the dental resin based on the interference chromatography measurement method, which achieves online real-time measurement of the internal strain field of the dental resin. When the apparatus according to the present embodiment is applied in clinical practice, the apparatus can analyze and detect the internal defects of the dental resin by measuring a change of the internal strain field of the tooth under a stress.

The apparatus for measuring an internal strain field of a dental resin according to the present embodiment will be further described in detail below.

As shown in FIG. 2, in the apparatus for measuring an internal strain field of a dental resin according to the present embodiment, in the optical measurement system 1, coherent light is provided by the light source 10, and the light source may employ a laser of which an output terminal is connected to an input terminal of the optical fiber coupler 11 through an optical fiber.

The optical fiber coupler 11 has one output terminal connected to the probe 2 through an optical fiber and the other output terminal connected to the optical component 12 for forming reference light.

In a specific embodiment, as shown in FIG. 2, the optical component 12 comprises at least a first lens 120, a first reflector 121, an optical path adjustment component and a second reflector 122 disposed in turn along an optical path. The first lens 120 is configured to adjust output light from the optical fiber to parallel light; and a normal of the first reflector 121 is at an angle of 45 degrees to a central axis of the first lens 120.

The optical path adjustment component comprises at least a third reflector 123 and a fourth reflector 124 disposed perpendicularly to each other and having respective reflection surfaces opposite to each other. The third reflector 123 is parallel to the first reflector 121, and the second reflector 122 is opposite to the fourth reflector 124 with an angle of 45 degrees between a normal of the second reflector 122 and a normal of the fourth reflector 124. The output light output from the optical fiber is adjusted by the first lens 120 to parallel light, which is incident on the first reflector 121. Reflection light from the first reflector 121 is incident on the third reflector 123 at an incident angle of 45 degrees, and after the light is reflected by the third reflector 123 and the fourth reflector 124 in turn, reflection light from the fourth reflector 124 is incident on the second reflector 122 perpendicularly. Light reflected from the second reflector 122 returns to the optical fiber coupler 11 through the original optical path to provide reference light.

The optical path adjustment component is displaceable in a direction of incident light thereon, as illustrated by a direction indicated by an arrow in FIG. 2. By adjusting a position of the optical path adjustment component in this direction, an optical path of the reference light may be adjusted. In practical measurements, it needs to adjust the optical path of the reference light and the optical path of the object light reflected by the measured object to be equal. Thereby, the optical path adjustment component may be used to adjust the optical path of the reference light to adjust an optical path difference between the reference light and the object light.

At the other input terminal of the optical fiber coupler 11, the photoelectric imaging apparatus 13 is disposed, which is configured to receive interference light formed by the object light reflected by the measured tooth and the reference light to obtain the interference spectrum. Preferably, a second lens 15, a reflective diffraction grating 14, and a third lens 16 are disposed in turn on an optical path between the input terminal of the optical fiber coupler 11 and the photoelectric imaging apparatus 13. When a broadband light source is used as the light source 10, the interference light is spectrally widened by the diffraction grating 14.

The second lens 15 is configured to to adjust the output light from the optical fiber to the parallel light, and the third lens 16 is configured to converge the parallel light from the grating on a light sensitive surface of the photoelectric imaging apparatus 13.

In the present embodiment, a Charge Coupled Device (CCD) camera may be used as the photoelectric imaging apparatus, and an optical fiber coupler having a splitting ratio of 50:50 is preferably used as the optical fiber coupler.

In the measurement apparatus according to the present embodiment, the optical measurement system 1 is connected to the probe 2 via a fiber jumper 4, so that the probe and the optical measurement system are conveniently connected and disconnected and a length of the fiber jumper may be changed as required by measurement.

In the measurement apparatus according to the present embodiment, the light source 10 and the photoelectric imaging apparatus 13 may be connected to the data processor 3 via a connection line. The data processor 3 may control the light source and process the measured data to obtain a measurement result.

A method for calculating an internal strain field of a dental resin according to an interference spectrum by the data processor in the measurement apparatus according to the present embodiment will be described below.

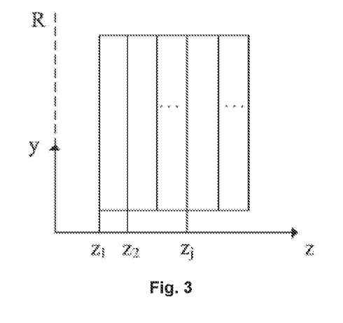

The dental resin has a multi-layer structure. Detection light which is irradiated to the measured tooth is reflected by various layers in the dental resin, and interference occurs between the formed reflection light and the reference light. Based thereon, a multi-layer structure model in the dental resin is established. As shown in FIG. 3, R represents a reference plane, zⱼ represents a distance between a j^{th} surface in the dental resin and the reference plane, and refractive indexes of various layers are denoted in turn as n₁, n₂, . . . , nⱼ, . . .

Correspondingly, the collected interference spectrum is described using the following equation:

$$I ( k ) = DC + AC + 2 {\sum }_{j = 1}^{M} \sqrt{{I}_{R} {I}_{j}} cos ( {φ}_{j 0} + 2 k \cdot {Λ}_{j} ) ;$$

where I(k) represents the intensity of the interference light, DC represents a direct current component, AC represents a self-coherent component, I_{R} represents intensity of the reference light, Iⱼ represents intensity of reflection light from a j^{th} surface, k is a wave number, k=2π/λ, λ is a wavelength, M is a number of surfaces involved in the interference, φⱼ₀ is an initial phase when interference occurs between a reference plane and the j^{th} surface, and ζⱼ is an optical path difference between the j^{th} surface and the reference plane.

A distance zⱼ between the j^{th} surface and the reference plane in the dental resin is calculated in accordance with the following equation:

$${z}_{j} = \frac{{Λ}_{j + 1} - {Λ}_{j}}{{n}_{j}} + {\sum }_{i = 1}^{j - 1} \frac{{Λ}_{i} - {Λ}_{i - 1}}{{n}_{i - 1}} ;$$

where nⱼ represents a refractive index, and Λⱼ is calculated using the following equation:

$${f}_{k} = \frac{1}{2 π} \cdot \frac{\partial ( {φ}_{j 0} + 2 k \cdot {Λ}_{j} )}{\partial k} = \frac{{Λ}_{j}}{π} ;$$

where fₖ represents a change frequency of the interference spectrum along a wave number k axis.

A maximum depth zₘₐₓ and a depth resolution zₘᵢₙ which may be measured by the measurement apparatus according to the present embodiment are respectively as follows:

$${z}_{ma x} = \frac{N {λ}_{c}^{2}}{4 Δ λ} ;$$

$${z}_{m i n} = \frac{{λ}_{c}^{2}}{2 Δ λ} ;$$

where λc and Δλ represent a central wavelength and a wavelength bandwidth of a low coherent broadband light source respectively, and N is a number of pixels of a line-scanning COD camera along the wave number k axis. When practical parameters are substituted into the equations, the measured depth may be up to the millimeter level, and the depth resolution may be at the micrometer level.

In the measurement apparatus according to the present embodiment, when the measured tooth is thermally deformed, an off-plane displacement and an off-plane strain in the dental resin may be calculated according to the measured interference spectrum.

Calculating the off-plane displacement and the off-plane strain in the dental resin according to the interference spectrum specifically comprises:
calculating an off-plane displacement wⱼ of the j^{th} surface in the dental resin according to the following equation:

$${w}_{j} = \frac{{Δφ}_{j}}{2 {k}_{c} \cdot {n}_{j - 1}} + \frac{1}{{n}_{j - 1}} {\sum }_{i = 1}^{j - 1} \{ [ {w}_{i - 1} - {w}_{i} ] \cdot {n}_{i - 1} + ( {z}_{i - 1} - {z}_{i} ) \cdot Δ {n}_{i - 1} \} + ( {z}_{j - 1} - {z}_{j} ) \cdot \frac{Δ {n}_{j - 1}}{{n}_{j - 1}} + {w}_{j - 1}$$

where Δφⱼ represents a phase difference between interference spectrums before and after the deformation, k_{c} represents a central wave number of output light from the light source, and Δnⱼ represents a difference between refractive indexes before and after the deformation.

An off-plane strain εⱼ of the j^{th} surface in the dental resin is calculated according to the following equation:

$${ɛ}_{j} = \frac{\partial {w}_{j}}{\partial z} = \frac{1}{2 {k}_{c} \cdot {n}_{j}} \cdot \frac{\partial {Δφ}_{j}}{\partial z} - \frac{Δ {n}_{j}}{{n}_{j}} .$$

The apparatus for measuring an internal strain field of a dental resin according to the present embodiment can perform on-line measurement to obtain a displacement field and a strain field at the time of thermal deformation of the dental resin, obtain measurement results such as a winding phase, an off-plane displacement field, an off-plane strain field etc., and can analyze internal defects of the resin according to changes of the displacement field and the strain field.

In practical measurements, when practical parameters are substituted into the equations, the measurement depth of the measurement apparatus according to the present embodiment can be up to the millimeter level, the depth resolution is at the micrometer level, and the measurement sensitivity of the strain field is at the microstrain level, so that it is possible to realize high accuracy measurement of the microstrain of the dental resin.

The apparatus for measuring an internal strain field of a dental resin according to the present embodiment detects the defects of the dental resin using the following method. Specifically, during the cooling of the measured tooth, the probe of the measurement apparatus is used to irradiate the measured tooth to obtain a measurement result of the internal strain field of the dental resin at a series of temperatures having a uniform temperature difference. Then, internal defects of the measured tooth can be analyzed according to the measurement result of the strain field at the series of temperatures.

Specifically, in clinical applications, before a tooth of a patient is detected, the patient may hold warm water at a temperature of about 40 degrees in the mouth for 10 seconds and then spit the water. Then the measurement apparatus is started and the probe irradiates the measured tooth of the patient. During the cooling of the tooth, plots of distributions of a displacement field and a strain field of the dental resin at 38° C., 37° C., 36° C., 35° C. and 34° C. are measured respectively, including measurement results of the winding phase, the off-plane displacement field, the off-plane strain field, and changes of the displacement field and the strain field at various temperatures are compared to analyze and detect the internal defects of the dental resin.

The apparatus for measuring an internal strain field of a dental resin according to the present disclosure is described in detail above, The principles and embodiments of the present disclosure have been described herein in detail with reference to specific examples, and the description of the above embodiments is only for the purpose of understanding the method according to the present disclosure and its core ideas. It should be pointed out that various modifications and adaptations may further be made by those of ordinary skill in the art to the present disclosure without departing from the principles of the present disclosure, which are also within the protection scope of the claims of the present disclosure.

1. An apparatus for measuring an internal strain field of a dental resin, comprising;
an optical measurement system, a probe and a data processor, wherein
the optical measurement system comprises a light source for providing coherent light, an optical fiber coupler, an optical component and a photoelectric imaging apparatus, wherein the optical fiber coupler has one input terminal connected to the light source, one output terminal connected to the probe through an optical fiber, the other output terminal provided with the optical component including a reflective element for forming reference light and the other input terminal provided with the photoelectric imaging apparatus for receiving interference light formed by object light and the reference light,
the probe is configured to irradiate detection light outputted from the optical fiber to a measured tooth and receive object light which is reflected by the tooth; and
the data processor is connected to the photoelectric imaging apparatus, and is configured to obtain a measurement result of the internal strain field of the measured dental resin according to an interference spectrum obtained through imaging by the photoelectric imaging apparatus.

2. The apparatus according to claim 1, wherein the optical component comprises at least a first lens, a first reflector, an optical path adjustment component and a second reflector disposed in turn along an optical path;
the first lens is configured to adjust output light from the optical fiber to parallel light;
a normal of the first reflector is at an angle of 45 degrees to a central axis of the first lens;
the optical path adjustment component comprises at least a third reflector and a fourth reflector disposed perpendicularly to each other and having respective reflection surfaces opposite to each other, the third reflector being parallel to the first reflector, and the second reflector being opposite to the fourth reflector with an angle of 45 degrees between a normal of the second reflector and a normal of the fourth reflector;
reflection light from the first reflector is incident on the third reflector at an incident angle of 45 degrees, and after the light is reflected by the third reflector and the fourth reflector in turn, reflection light from the fourth reflector is incident on the second reflector perpendicularly; and
the optical path adjustment component is displaceable in a direction of incident light thereon.

3. The apparatus according to claim 1, wherein the optical measurement system is connected to the probe via a fiber jumper.

4. The apparatus according to claim 1, wherein a second lens, a reflective diffraction grating, and a third lens are disposed in turn on an optical path between the input terminal of the optical fiber coupler and the photoelectric imaging apparatus.

5. The apparatus according to claim 1, wherein at least a fourth lens for adjusting a light beam is disposed in the probe.

6. The apparatus according to claim 1, wherein the optical fiber coupler is an optical fiber coupler having a splitting ratio of 50:50.

7. The apparatus according to claim 1, wherein the photoelectric imaging apparatus is a Charge Coupled Device (CCD) camera.

8. The apparatus according to claim 1, wherein the data processor is configured to obtain a measurement result of the internal strain field of the measured dental resin according to an interference spectrum by:
calculating the collected interference spectrum using the following equation:
$$I ( k ) = DC + AC + 2 {\sum }_{j = 1}^{M} \sqrt{{I}_{R} {I}_{j}} cos ( {φ}_{j 0} + 2 k \cdot {Λ}_{j} ) ;$$
where I(k) represents the intensity of the interference light, DC represents a direct current component, AC represents a self-coherent component, I_{R} represents intensity of the reference light, Iⱼ represents intensity of reflection light from a j^{th} surface, k is a wave number, k=2π/λ, λ is a wavelength, M is a number of surfaces involved in the interference, φⱼ₀ is an initial phase when interference occurs between a reference plane and the j^{th} surface, and Λⱼ is an optical path difference between the j^{th} surface and the reference plane; and
calculating a distance zⱼ between the j^{th} surface and the reference plane in the dental resin in accordance with the following equation:
$${z}_{j} = \frac{{Λ}_{j + 1} - {Λ}_{j}}{{n}_{j}} + {\sum }_{i = 1}^{j - 1} \frac{{Λ}_{i} - {Λ}_{i - 1}}{{n}_{i - 1}} ;$$
where nⱼ represents a refractive index, and Λⱼ is calculated using the following equation:
$${f}_{k} = \frac{1}{2 π} \cdot \frac{\partial ( {φ}_{j 0} + 2 k \cdot {Λ}_{j} )}{\partial k} = \frac{{Λ}_{j}}{π} ;$$
where fₖ represents a change frequency of the interference spectrum along a wave number k axis.

9. The apparatus according to claim 8, wherein the data processor is configured to obtain a measurement result of the internal strain field of the measured dental resin according to an interference spectrum by:
calculating an off-plane displacement wⱼ of the j^{th} surface in the dental resin according to the following equation:
$${w}_{j} = \frac{{Δφ}_{j}}{2 {k}_{c} \cdot {n}_{j - 1}} + \frac{1}{{n}_{j - 1}} {\sum }_{i = 1}^{j - 1} \{ [ {w}_{i - 1} - {w}_{i} ] \cdot {n}_{i - 1} + ( {z}_{i - 1} - {z}_{i} ) \cdot Δ {n}_{i - 1} \} + ( {z}_{j - 1} - {z}_{j} ) \cdot \frac{Δ {n}_{j - 1}}{{n}_{j - 1}} + {w}_{j - 1} ;$$
where Δφⱼ represents a phase difference between interference spectrums before and after deformation, k_{c} represents a central wave number of output light from the light source, and Δnⱼ represents a difference between refractive indexes before and after the deformation; and
calculating the off-plane strain εⱼ of the j^{th} surface in the dental resin according to the following equation:
$${ɛ}_{j} = \frac{\partial {w}_{j}}{\partial z} = \frac{1}{2 {k}_{c} \cdot {n}_{j}} \cdot \frac{\partial {Δφ}_{j}}{\partial z} - \frac{Δ {n}_{j}}{{n}_{j}} .$$
